(19) United States
(12) Patent Application Publication
(10) Pub. No.: US 2018/0021879 A1
(43) Pub. Date: Jan. 25, 2018

(54) V-Cut Tooling For Ultrasonic Tube Sealer And Method Of Cutting And Sealing A Tube Using The V-Cut Tooling

(71) Applicant: Branson Ultrasonics Corporation, Danbury, CT (US)

(72) Inventors: Guillermo COTO, Monroe, CT (US); Michael DAVIS, Beacon Falls, CT (US)

(73) Assignee: Branson Ultrasonics Corporation, Danbury, CT (US)

(21) Appl. No.: 15/647,517

(22) Filed: Jul. 12, 2017

Related U.S. Application Data
(60) Provisional application No. 62/364,383, filed on Jul. 20, 2016.

(51) Int. Cl. B23K 20/10; B29C 65/74; B29C 65/00

(52) U.S. Cl. CPC B23K 20/10; B29C 66/43121; B29C 65/7443; B29C 66/2442; B29L 2023/20

(57) ABSTRACT

A copper or aluminum tube is cut and sealed in an ultrasonic tube sealer. A section of the tube is placed laterally in a V-shaped recess of a center member of a forming tool of an anvil of the ultrasonic tube sealer. The anvil and a horn tip are brought together with the center member received in a channel of a forming tool of the horn tip to cut the tube with the cut tube having cut ends on opposed sides of the center member. At least one of the cut ends is pinched together between the forming tool of the anvil and the forming tool of the ultrasonic horn tip and the ultrasonic horn is ultrasonically vibrated to ultrasonically weld the at least one cut end together to seal that cut end.

### CROSS-REFERENCE TO RELATED APPLICATIONS

This application claims the benefit of U.S. Provisional Application No. 62/364,383, filed on Jul. 20, 2016. The entire disclosure of the above application is incorporated herein by reference.

### FIELD

The present disclosure relates to ultrasonic tube sealers and tooling therefor.

### BACKGROUND

This section provides background information related to the present disclosure which is not necessarily prior art.

A model of a typical ultrasonic tube sealer 100 is shown in FIG. 1. Typical components of ultrasonic tube sealer 100 include an ultrasonic stack 101 having an ultrasonic transducer 102, a booster 104 and an ultrasonic horn 106. Ultrasonic tube sealer 100 also includes a power supply 103 and an anvil 116. Electrical energy from power supply 103 at a frequency of 20-60 kHz is converted to mechanical energy by the ultrasonic transducer 102. The mechanical energy converted in the ultrasonic transducer 102 is transmitted to a tube 108 to be sealed through the booster 104 and the ultrasonic horn 106. The booster 104 and the ultrasonic horn 106 perform the functions of transmitting the mechanical energy as well as transforming mechanical vibrations from the ultrasonic transducer 102 by a gain factor.

The mechanical vibration that results on an ultrasonic horn tip 110 is the motion that performs the task of sealing the tube 108 by ultrasonically welding tube 108. Ultrasonic horn tip 110 illustratively includes one or more forming tools 111 on sides of ultrasonic horn tip 110. A portion 112 of the tube 108 to be cut and sealed is placed between one of the forming tools 111 of ultrasonic horn tip 110 and a forming tool 114 of anvil 116 and supported by forming tool 114. The forming tool 111 of ultrasonic horn tip 110 is brought into contact with portion 112 of tube 108 pinching portion 112 between the forming tool 111 of ultrasonic horn tip 110 and the forming tool 114 of anvil 116. In some ultrasonic tube sealers, anvil 116 is mounted on an anvil arm 120 that is moved by an actuator (not shown) to bring horn tip 110 and anvil 116 together. Typically, ultrasonic horn tip 110 is brought to a pre-determined distance from anvil 116 so that there is a pre-set gap between the forming tools 111, 114 of ultrasonic horn tip 110 and anvil 116 in which the portion 112 of tube 108 to be sealed is situated. Ultrasonic vibrations are applied via the ultrasonic horn tip 110 to the portion 112 of tube 108 where tube 108 is to be sealed. The ultrasonic vibrations generate heat to ultrasonically weld the material of the portion 112 of tube 108 together where portion 112 is pinched between the forming tools 111, 114 of ultrasonic horn tip 110 and anvil 116. The forming tools 111, 114 of ultrasonic horn tip 110 and anvil 116 also cut the tube 108 and typically do so during active welding which is when ultrasonic vibrations are being applied to portion 112 of tube 108 by ultrasonic horn tip 110. The electrical energy provided by power supply 103 is then stopped and the portion 112 of tube 108 held closed between the forming tools of ultrasonic horn tip 110 and anvil 116 for a dwell period which is a brief period of time. An example of such a prior art ultrasonic tube sealer is the Branson Ultraseal® Ultrasonic Tube Welding System available from Branson Ultrasonics Corporation, Danbury, Conn.

The ultrasonic tube sealer 100 is controlled by a controller 118 that has inputs and outputs coupled to the applicable components of ultrasonic tube sealer 100. It should be understood that power supply 103 can include controller 118 (as shown in FIG. 1) or controller 118 can be a separate device from power supply 103.

Typically, the forming tools of ultrasonic horn tip 110 and the anvil 116 cut and seal the tube 108 in a straight line perpendicularly across the tube at portion 112 of tube 108, relying on a back stop for orientation of the tube.

### SUMMARY

This section provides a general summary of the disclosure, and is not a comprehensive disclosure of its full scope or all of its features.

In accordance with an aspect of the present disclosure, tooling for an ultrasonic tube sealer includes an ultrasonic horn tip and an anvil. The ultrasonic horn tip and the anvil each have at least one forming tool. The forming tool of the anvil includes a center member extending from a base with the base having sealing members on opposed sides of the center member. The center member includes at least one V-shaped recess having opposed sides that angle outwardly away from each other from an apex of the V-shaped recess at an acute angle. In an aspect, the forming tool of the ultrasonic horn tip is a U-shaped channel member that extends axially along the ultrasonic horn tip having opposed sides with a channel therebetween.

In an aspect, the center member of the forming tool of the anvil has a plurality of V-shaped recesses.

In an aspect, the horn tip includes a plurality of the forming tools of the ultrasonic horn tip that are channel members.

In an aspect, a tooling kit includes the ultrasonic horn tip and the anvil.

In an aspect, the ultrasonic tooling is used in an ultrasonic sealer to cut and seal tube. The tube is placed laterally across one of the V-shaped recesses of the center member of the forming tool of the anvil with a section of the tube received in the V-shaped recess. With an ultrasonic transducer of the ultrasonic sealer de-energized, the anvil and horn tip are brought together. In an aspect, the anvil and horn tip are brought together with a cutting force to an interim pre-set distance to cut at least ninety percent through the tube. When the horn tip and anvil have been are brought together to the interim pre-set distance, the ultrasonic transducer is energized and the horn tip and anvil are continued to be brought together to a final pre-set distance. Once the horn tip and anvil have been brought together to the final pre-set distance, they are held at a welding force at that final pre-set distance until welding is completed. The horn tip and anvil are then moved apart.

In a variation, the horn tip and anvil are brought together with the cutting force to the final pre-set distance with the transducer de-energized to cut one hundred percent through the tube. When the horn tip and anvil have been brought together to the final pre-set distance, they are held at the welding force at that final pre-set distance until welding is completed. The horn tip and anvil are then moved apart.

### DRAWINGS

The drawings described herein are for illustrative purposes only of selected embodiments and not all possible implementations, and are not intended to limit the scope of the present disclosure.

FIG. 1 is a diagrammatic view of a prior art ultrasonic tube sealer;

FIG. 2 is a perspective view of ultrasonic tooling in accordance with an aspect of the present disclosure having an ultrasonic horn tip and an anvil showing the ultrasonic horn tip on an ultrasonic horn;

FIG. 3 is a perspective view of the anvil of FIG. 2 in which a tube to be cut and sealed has been received;

FIG. 4 is a diagrammatic view of a tube that has been cut and sealed using the ultrasonic horn tip and anvil of FIG. 2;

FIG. 5 is a flow chart of a control routine for controlling an ultrasonic sealer to cut and seal a tube using the ultrasonic tooling of FIG. 2; and

FIG. 6 is a flow chart of a control routine that is a variation of the control routine of FIG. 5.

Corresponding reference numerals indicate corresponding parts throughout the several views of the drawings.

### DETAILED DESCRIPTION

Example embodiments will now be described more fully with reference to the accompanying drawings.

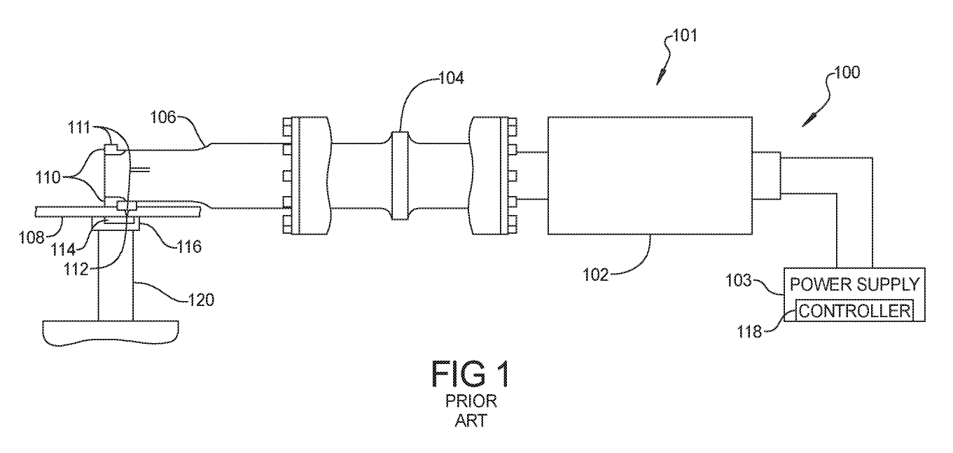

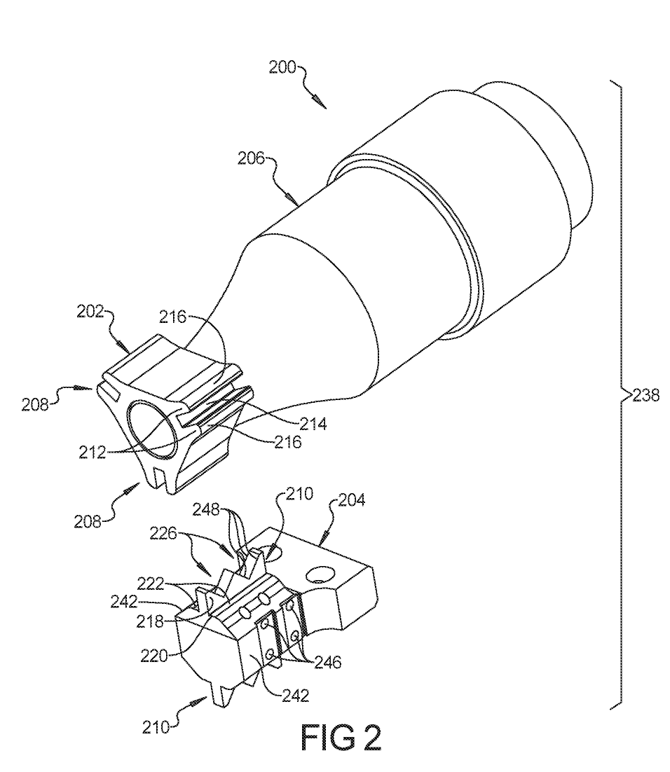

With reference to FIG. 2, in accordance with an aspect of the present disclosure, ultrasonic tooling 200 for an ultrasonic tube sealer such as ultrasonic tube sealer 100 of FIG. 1 has an ultrasonic horn tip 202 and an anvil 204. Ultrasonic horn tip 202 is shown received on an ultrasonic horn 206. Ultrasonic horn tip 202 includes one or more forming tools 208 (three in the example of FIG. 2) and anvil 204 includes forming tool 210. It should also be understood that when ultrasonic tooling 200 is used with ultrasonic tube sealer 100, ultrasonic horn tip 202 and anvil 204 replace ultrasonic horn tip 110 and anvil 116.

Each forming tool 208 of horn tip 202 is illustratively a U-shaped channel member that extends longitudinally along ultrasonic horn tip 202 having opposed sides 212 with a channel 214 therebetween. Opposed sides 212 have outer edges 216. Each forming tool 208 thus has a U-shaped cross-section.

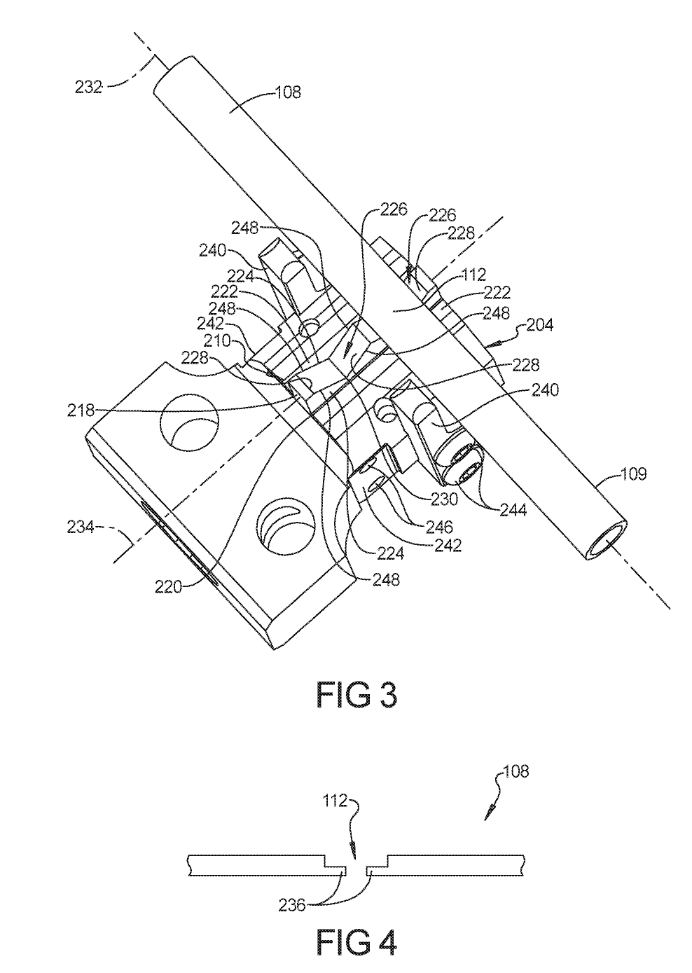

As best shown in FIG. 3, forming tool 210 of anvil 204 includes a center member 218 that projects upwardly (as oriented in FIG. 2) from a base 220 of forming tool 210 and extends longitudinally along base 220. Base 220 includes sealing members 222 that extend longitudinally along each side 224 of center member 218. Center member 218 includes one or more V shaped recesses 226 therein (two in the example of FIG. 2) having sides 228 that angle outwardly away from each other (upwardly as oriented in FIG. 2) from an apex 230 of the V-shaped recess 226 at an acute angle with respect to each other. Each forming tool 210 opens toward ultrasonic horn tip 202 when anvil 204 and ultrasonic horn tip 202 are in place in an ultrasonic tube sealer such as ultrasonic tube sealer 100 of FIG. 1. When center member has a plurality of V-shaped recesses 226, such as shown in the example of FIGS. 2 and 3, the V-shaped recesses are disposed longitudinally along center member 218 with respect to each other.

In an aspect, anvil 204 includes upwardly extending guide posts 240 (shown in FIG. 3 but not in FIG. 2) removably attached to anvil 204 on opposed lateral sides 242 of anvil 204 such as with cap screws 244 that are tightened into threaded holes 246 in sides 242 of anvil 204. Guide posts 240 are attached to anvil 204 so that they are adjacent the V-shaped recess 226 that is being used to cut and seal tube 108. When a different one of the V-shaped recesses 226 is to be used to cut and seal tube 108, guide posts 240 are repositioned to the appropriate location and reattached to anvil 204 with cap screws 244.

When a tube 108 is to be cut and sealed by an ultrasonic tube sealer such as ultrasonic tube sealer 100 of FIG. 1 using ultrasonic tooling 200, tube 108 is placed laterally across center member 218 of forming tool 210 with portion 112 of tube 108 nested in one of the V-shaped recesses 226 of forming tool 210 of anvil 204, as shown in FIG. 3. Guide posts 240 act to guide tube 108 into the V-shaped recess 226 when the portion of 112 of tube 108 is placed in that V-shaped recess 226. A longitudinal axis 232 of tube 108 is thus perpendicular to a longitudinal axis 234 of center member 218 of forming tool 210 of anvil 204. Tube 108 is illustratively a copper or aluminum tube. The V-shaped recess and associated sides 228 provide a location to nest portion 112 of tube 108 in forming tool 210 and also to align tube 108 so that its longitudinal axis 232 is perpendicular to the longitudinal axis 234 of forming tool 210. Outer edges of sides 228 of V-shaped recess 226 provide cutting edges to cut portion 112 of tube 108.

Ultrasonic horn tip 202 and anvil 204 are then brought together to cut and seal tube 108. As ultrasonic horn tip 202 and anvil 204 come together, center member 218 of forming tool 210 of anvil 204 is received in channel 214 of one of forming tools 208 of ultrasonic horn tip 202. As ultrasonic horn tip 202 and anvil 204 are brought together, forming tool 208 of ultrasonic horn tip 202 and forming tool 210 of anvil 204 cooperate to cut portion 112 of tube 108, with cut ends 236 (FIG. 4) of tube 108 on opposed sides of center member 218 being sealed together by being ultrasonically welded together. The V-shaped recess

Ultrasonic tube sealer 100 having ultrasonic tooling 200 is controlled by power supply 103 to bring ultrasonic horn tip 202 and anvil 204 partially together with a cutting force, illustratively to an interim pre-set distance apart, to cut tube 108 at least ninety percent through before energizing ultrasonic transducer 102 with power supply 103 to ultrasonically vibrate ultrasonic horn 206 and thus ultrasonic horn tip 202. Ultrasonic horn tip 202 and anvil 204 are then continued to be brought together to a final pre-set distance apart. As ultrasonic horn tip 202 and anvil 204 are brought to the final pre-set distance apart, portion 112 of tube 108 is pinched between edges 216 of opposed sides 212 of forming tool 208 of ultrasonic horn tip 202 and sealing members 222 of base 220 of forming tool 210 of anvil 204. Bringing ultrasonic horn tip 202 and anvil 204 to the final pre-set distance apart completes cutting portion 112 of tube 108. Ultrasonic horn tip 202 and anvil 204 are held at the final pre-set distance with a weld force until active welding is completed. When ultrasonic horn tip 202 and anvil 204 are at the final pre-set distance apart, tube 108 has been cut through at portion 112 and cut ends 236 (FIG. 4) of tube 108 on respective sides of the cut are being sealed together by the ultrasonic vibration of ultrasonic horn tip 202 against portion 112 of tube 108 which ultrasonically welds cut ends 236 of tube 108 together. It should be understood that when ultrasonic horn tip 202 and anvil 204 are at the final pre-set distance apart, edges 216 of forming tool 208 of ultrasonic horn tip 202 and sealing surfaces 222 of base 220 of forming tool 210 of anvil 204 are spaced from each other by slightly less than twice the thickness of the thickness of a wall 109 of tube 108. After completion of the weld, ultrasonic horn tip 202 and anvil 204 are moved away from each other.

In an aspect, ultrasonic horn tip and anvil are brought together with the cutting force to the final pre-set distance apart to cut tube 108 one-hundred percent the way through before ultrasonic transducer 102 is energized. Once ultrasonic horn tip and anvil have been brought together to the final pre-set distance, thus cutting tube 108 one-hundred percent the way through, they are then held together with the weld force at the final pre-set distance and ultrasonic transducer 102 energized to ultrasonically weld cut ends 236 of tube 108 together. After completion of the weld, ultrasonic horn tip 202 and anvil 204 are moved away from each other.

In an aspect, a tooling kit 238 includes ultrasonic horn tip 202 and anvil 204. In the example embodiment shown in FIG. 2, ultrasonic horn tip 202 is a replaceable component and removably mountable on ultrasonic horn 206 and anvil 204 is also a replaceable component and removably mountable on anvil arm 120. Ultrasonic horn tip 202 illustratively has a plurality of forming tools 208 thereon, three in the example of FIG. 2. When one forming tool 208 has worn sufficiently that it is no longer useable, ultrasonic horn tip 202 is rotated on ultrasonic horn 206 so that another of the forming tools 208 is then the forming tool being used for cutting and ultrasonic sealing. When sides 228 of a V-shaped recess 226 of center member 218 of forming tool 210 of anvil 204 becomes worn, another of the V shaped recesses 226 of center member 218 of forming tool 210 is used for the cutting and ultrasonic sealing operation. In this regard, as shown in the example of FIG. 2, both V shaped recesses 226 are received in channel 214 when ultrasonic horn tip 202 and anvil 204 are brought together.

The V-shaped recess 226 positions tube 108 when portion 112 of tube 108 is nested in V-shaped recess 226 in a proper orientation for cutting and sealing, which in an aspect is with the longitudinal axis 232 of tube 108 perpendicular to longitudinal axis 234 of center member 218. In an aspect, surfaces 229 of sides 228 of V-shaped recess 226 have a width sufficient to self-align portion 112 of tube 108 therein so that the longitudinal axis 232 of tube 108 is perpendicular to longitudinal axis 234 of center member 218. In an example, when tube 108 has a 1/4 inch diameter, surfaces 229 have a width of at least ⅛ inch. In an aspect, surfaces 229 have a width that is at least fifty percent that of a diameter of tube 108 at portion 112.

Tube 108 may, for example, be a copper charge tube leading to a refrigerant charge inlet of a compressor of a refrigeration or air conditioning unit. As discussed above, tube 108 may also be an aluminum tube.

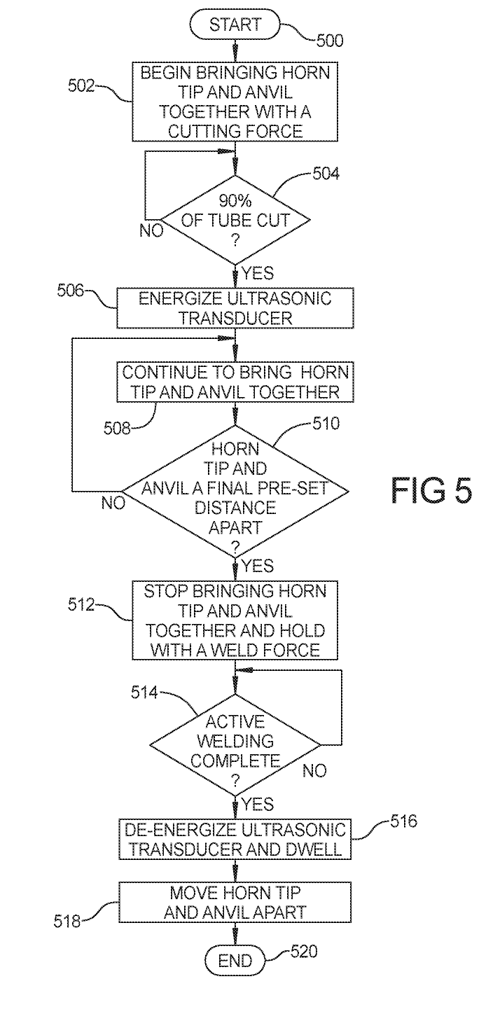

FIG. 5 is a flow chart showing an illustrative control routine of control logic for the control of an ultrasonic sealer, such as ultrasonic tube sealer 100, in which ultrasonic tooling 200 is used to cut and seal tubes, such as tube 108. The control routine starts at 500. At 502, the control routine starts bringing horn tip 202 and anvil 204 together with a cutting force. In an aspect, anvil 204 is situated on an actuator (not shown) and anvil 204 is moved toward ultrasonic horn tip 202. At 504, the control routine checks whether at least ninety percent of tube 108 has been cut, such as by checking whether ultrasonic horn tip 202 and anvil 204 have been brought together to an interim pre-set distance apart from each other. If not, the control routine branches back to 504 and continues to bring ultrasonic horn tip 202 and anvil 204 together. If so, the control routine proceeds to 506 where it energizes ultrasonic transducer 102 with power supply 103 and at 508 continues to bring ultrasonic horn tip 202 and anvil 204 together. At 510, the control routine checks if ultrasonic horn tip 202 and anvil 204 have been brought together to a final pre-set distance apart. If not, the control routine branches back to 508 and continues to bring ultrasonic horn tip 202 and anvil 204 together. If so, the control routine proceeds to 512 where it stops the bringing ultrasonic horn tip 202 and anvil 204 together and holds ultrasonic horn tip and anvil together with a weld force at the final pre-set distance. At 514, the control routine checks whether active welding has been completed. In this context, active welding is when ultrasonic transducer 102 is energized. If so, the control routine proceeds to 516 where it de-energizes ultrasonic transducer 102 by turning off the power to it from power supply 103 and holds the ultrasonic horn tip 202 and anvil 204 in position for a dwell period that allows the material at cut ends 236 of tube 108 to solidify. After the dwell period the ultrasonic welding is complete and the control routine proceeds to 518 where it moves ultrasonic horn tip 202 and anvil 204 apart so that the next sealing cycle can take place.

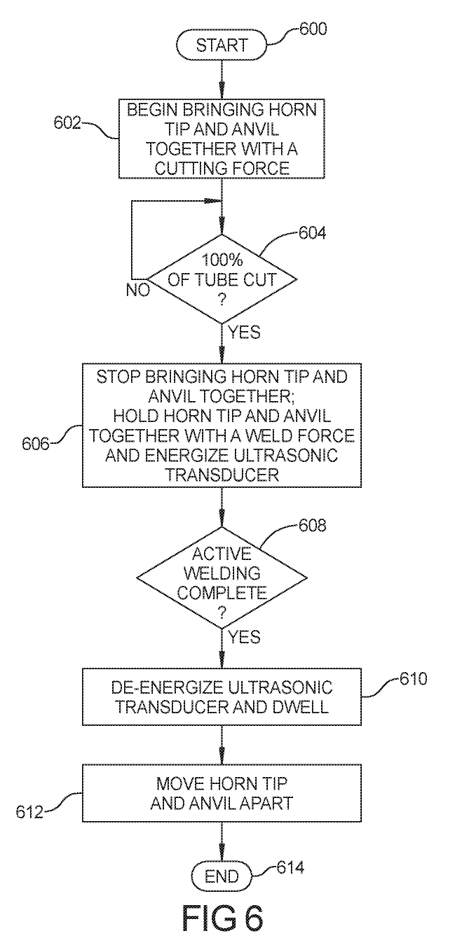

FIG. 6 is a flow chart showing an illustrative control routine that is a variation of the control routine of FIG. 5 in which the ultrasonic horn tip 202 and anvil 204 are brought together with the cutting force to cut tube 108 one-hundred percent the way through before ultrasonic transducer 102 is energized. The control routine starts at 600. At 602, the control routine begins bringing horn tip 202 and anvil 204 together with a cutting force. At 604, the control routine checks whether tube 108 has been cut one-hundred percent the way through, such as by checking whether ultrasonic horn tip 202 and anvil 204 have been brought together to a final pre-set distance apart from each other. If not, the control routine branches back to 604 and continues to bring ultrasonic horn tip 202 and anvil 204 together. If so, the control routine proceeds to 606 where it holds ultrasonic horn tip and anvil 204 together at a weld force, such as at the final pre-set distance and energizes ultrasonic transducer 102 with power supply 103. At 608, the control routine checks whether active welding has been completed. If so, the control routine proceeds to 610 where it de-energizes ultrasonic transducer 102 by turning off the power to it from power supply 103 and holds the ultrasonic horn tip 202 and anvil 204 in position for a dwell period that allows the material at cut ends 236 of tube 108 to solidify. After the dwell period the ultrasonic welding is complete and the control routine proceeds to 612 where it moves ultrasonic horn tip 202 and anvil 204 apart so that the next sealing cycle can take place.

As used herein, the term controller, control module, control system, or the like may refer to, be part of, or include an Application Specific Integrated Circuit (ASIC); an electronic circuit; a combinational logic circuit; a field programmable gate array (FPGA); a processor (shared, dedicated, or group) that executes code; a programmable logic controller, programmable control system such as a processor based control system including a computer based control system, a process controller such as a PID controller, or other suitable hardware components that provide the described functionality or provide the above functionality when programmed with software as described herein; or a combination of some or all of the above, such as in a system-on-chip. The term module may include memory (shared, dedicated, or group) that stores code executed by the processor. When it is stated that such a device performs a function, it should be understood that the device is configured to perform the function by appropriate logic, such as software, hardware, or a combination thereof.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of cutting and sealing a copper or aluminum tube, comprising:
placing a section of the tube laterally in a V-shaped recess of a center member of a forming tool of an anvil of an ultrasonic tube sealer; and
having the ultrasonic tube sealer bring the anvil and a horn tip together with the center member received in a channel of a forming tool of the horn tip to cut the tube with the cut tube having cut ends on opposed sides of the center member and pinching at least one of the cut ends together between the forming tool of the anvil and the forming tool of the ultrasonic horn tip and having the ultrasonic tube sealer ultrasonically vibrate the ultrasonic horn tip to ultrasonically weld the at least one cut end together to seal that cut end.

2. The method of claim 1 including pinching both cut ends together and ultrasonically welding both cut ends together to seal both cut ends.

3. The method of claim 1 including having the ultrasonic tube sealer bring the ultrasonic horn tip and anvil together with a cutting force to an interim pre-set distance apart with an ultrasonic transducer of the ultrasonic tube sealer de-energized to cut the tube at least ninety percent the way through with the ultrasonic transducer of the ultrasonic tube sealer de-energized, having the ultrasonic tube sealer energize the ultrasonic transducer when the anvil and horn tip are at the interim pre-set distance apart and bringing the ultrasonic horn tip and anvil together with the ultrasonic transducer energized to a final pre-set distance apart and once the ultrasonic horn tip and anvil are at the final pre-set distance apart , having the ultrasonic tube sealer hold the ultrasonic horn tip and anvil together at a welding force until the ultrasonic welding is complete.

4. The method of claim 1 including having the ultrasonic tube sealer bring the ultrasonic horn tip and anvil together with a cutting force to a final pre-set distance apart with an ultrasonic transducer of the ultrasonic tube sealer de-energized to cut the tube one-hundred percent of the way through with the ultrasonic transducer de-energized, having the ultrasonic tube sealer energize the ultrasonic transducer when the anvil and horn tip are at the final pre-set distance apart and also having the ultrasonic tube sealer hold the ultrasonic horn tip and anvil together at a welding force until the ultrasonic welding is complete.

5. An anvil for an ultrasonic tube sealer, comprising:
at least one forming tool that includes a center member that projects upwardly from a base of the forming tool and extends longitudinally along the base of the forming tool;
the base of the forming tool including sealing members that extend longitudinally along each side of the center member; and
the center member having at least one V-shaped recess therein having sides that angle outwardly away from each other from an apex of the V-shaped recess at an acute angle with respect to each other.

6. The anvil of claim 5 wherein the center member includes a plurality of V-shaped recesses therein disposed longitudinally along the center member with respect to each other.

7. The anvil of claim 6 including a pair of upwardly extending guide post removably attached to opposite sides of the anvil adjacent one of the V-shaped recesses.

8. The anvil of claim 6 including a plurality of the forming tools.

9. An ultrasonic horn tip for an ultrasonic horn of an ultrasonic tube sealer, comprising:
at least one forming tool that is a U-shaped channel member that extends longitudinally along the ultrasonic horn tip having opposed sides with a channel therebetween.

10. The ultrasonic horn tip of claim 9 including a plurality of the forming tools.

11. A tooling kit for an ultrasonic tube sealer, comprising:
an ultrasonic horn tip and an anvil;
the ultrasonic horn tip including at least one horn tip forming tool that is a U-shaped channel member that extends longitudinally along the ultrasonic horn tip having opposed sides with a channel therebetween; and
the anvil including an anvil forming tool that includes a center member that projects upwardly from a base of the anvil forming tool and extends longitudinally along the base of the anvil forming tool, the base of the anvil forming tool including sealing members that extend longitudinally along each side of the center member, the center member having at least one V-shaped recess therein having sides that angle outwardly away from each other from an apex of the V-shaped recess at an acute angle with respect to each other.

12. The tooling kit of claim 11 wherein the wherein the center member of the anvil forming tool includes a plurality of V-shaped recesses therein disposed longitudinally along the center member with respect to each other.

13. The tooling kit of claim 12 wherein the anvil includes a pair of upwardly extending guide post removably attached to opposite sides of the anvil adjacent one of the V-shaped recesses.

14. The tooling kit of claim 12 wherein the anvil includes a plurality of the anvil forming tools.

15. The tooling kit of claim 10 wherein the horn tip includes a plurality of the horn tip forming tools.
